(19) United States
(12) Patent Application Publication
(10) Pub. No.: US 2021/0087505 A1
(43) Pub. Date: Mar. 25, 2021

(54) TANK FOR SEPARATING SOLIDS FROM A WORT COMPRISING COOLING MEANS

(71) Applicant: Poppels Bryggeri AB, Jonsered (SE)

(72) Inventor: Daniel GRANATH, Härryda (SE)

(73) Assignee: Poppels Bryggeri AB, Jonsered (SE)

(21) Appl. No.: 16/498,904

(22) PCT Filed: Mar. 28, 2018
(86) PCT No.: PCT/EP2018/057889

§ 371 Date: Sep. 27, 2019

(30) Foreign Application Priority Data
Mar. 29, 2017 (SE) 1750369-9

(51) Int. Cl. C12C 7/26; B01D 21/00; B01D 21/26; C12C 7/24

(52) U.S. Cl. CPC C12C 7/26; B01D 21/009; B01D 2221/06; C12C 7/24; B01D 21/265

(57) ABSTRACT

A tank for separating solids from a wort, the tank including: a container having inner surface portions defining an interior container space, and outer surface portions facing away from the interior container space; a whirlpool arrangement configured create a whirl of the wort; wherein the tank further includes a cooling arrangement configured to cool at least a portion of the interior container space for cooling the wort.

### TECHNICAL FIELD OF THE INVENTION

The present invention relates to the field of brewing beer and beer brewing equipment, and more specifically to a tank for separating solids from a wort, and to a method for reducing the temperature of a wort inside a whirlpool.

### BACKGROUND OF THE INVENTION

Beer is typically made of water, grains, hops and yeast, in a process including multiple process steps. Prior to the brewing process, grains, typically barley grains, are made ready for brewing in a process called malting. During the malting, starches in the barley are released. In the brewing process, malt is mashed in a process called mashing in which the malt is mixed with water at a moderately high temperature for about one hour. In the mashing process starches released during the malting is converted into sugars that can be fermented. The result of the mashing process is a sugar-rich liquid containing the residual grains. In a subsequent step, known as lautering, the residual grains in the mash are removed, resulting in a more or less clear liquid called wort.

The wort is then transferred to a boiling kettle in a process step commonly referred to as boiling. During boiling of the wort, the temperature is typically held above the boiling temperature in order to sterilize the wort and to stop enzymatic activity. Hops are also typically added during the boiling step. Subsequent to the boiling step, the wort is sent to a whirlpool to separate any solids from the wort. After the solids have been removed, the wort is transferred to a cooler where the wort is cooled in order to reduce the amount of bitterness extracted from the hops. After cooling, the wort is moved to a fermenter, where yeast is added and fermentation begins.

If the wort is not cooled after the solids have been separated therefrom, the hops will quickly make the beer bitter. Thus, effective cooling of the wort is important for producing beer that tastes good.

### SUMMARY OF THE INVENTION

An object of the present invention is therefore to alleviate the abovementioned problems and provide a tank for separating solids from a wort while lowering the temperature of said wort.

The above and other objects which will be evident from the following description are achieved by a tank according to the present invention.

According to a first aspect of the present invention, a tank for separating solids from a wort is provided, said tank comprising: a container having inner surface portions defining an interior container space, and outer surface portions facing away from said interior container space; a whirlpool arrangement configured to create a whirl of said wort; wherein said tank further comprises a cooling arrangement configured to cool at least a portion of said interior container space for cooling the wort, and wherein said cooling arrangement is arranged in said container between said inner surface portions and said outer surface portions.

According to one example embodiment, the inner surface portions are curved. For example, the inner surface portions may be rounded. According to one example embodiment, the outer surface portions are curved. For example, the outer surface portions may be rounded.

According to one example embodiment, said interior container space has a circular, or oval, cross section. According to one example embodiment, said container is barrel-shaped. By having a circular cross section of the interior container space, a controlled whirlpool having a relatively fixed rotational midpoint may be achieved. This allows for an effective solid separation, as the solids that gather in the centre of rotation of the whirlpool are not disturbed by a moving, unstable or collapsing whirlpool.

According to one example embodiment, said tank further comprises a container inlet for transporting the wort into said interior container space.

According to one example embodiment, said tank further comprises a container outlet for transporting the wort out of said interior container space.

According to one example embodiment, said container outlet is located lower than said container inlet. The relative direction lower is to be interpreted in relation to the gravitational direction. This configuration allows for the extraction of a wort through said container outlet, that contains less solids than the wort that is fed into the container inlet of said tank. As the solids that are to be separated from the wort are caused to move towards a centre of the interior container space by the whirlpool that is created in said interior container space, and then settle in a cone-shaped pile on the bottom of the container, removing the wort from the interior container space by means of a container outlet that is located near a peripheral portion of the lower portion or bottom of the container is beneficial.

Said whirlpool arrangement is to be understood as being an arrangement configured to cause a whirlpool in the wort. When a whirlpool is created in the wort, any solids suspended therein are forced towards the centre of the whirlpool by fluid pressure from the portion of the wort that flows in the outer or peripheral portion of the whirlpool. A whirlpool arrangement is to be understood as being either a moving component configured to stir the wort into a whirlpool, such as a mixer or a rotating arm, or a stationary component e.g. arranged to cooperate with said container inlet in order to cause the wort to whirl. For example, the whirlpool arrangement could be a portion of said container or said inner surface portions of said container that is arranged to guide the wort entering the container so that it flows in a circumferential direction along said inner surface portions. The whirlpool arrangement could additionally or alternatively be a device used by an operator or brewer to impart a rotational movement to the wort. Such a device could for example be a ladle or a paddle. The whirlpool arrangement could additionally or alternatively be a portion of said container inlet that is arranged to discharge the wort in a direction that is tangential, or at least partly or mainly tangential, to a portion of the inner surface portions. Injecting the wort into the interior container space in a direction that is (at least partly or mainly) tangential to the inner surface portions adjacent to the container inlet causes the wort to rotate inside said container, thus creating a whirlpool. That is, the flow of wort into the interior container space via said container inlet, is adapted such that said whirlpool, or whirl, of said wort is formed, as understood by those skilled in the art.

Thus, according to one example embodiment, said container inlet is comprised in said whirlpool arrangement. That is, the container inlet is sized and dimensioned in order to facilitate the creation of a whirl of the wort inside the container. Additionally or alternatively, a portion of said container or said inner surface portions of said container that is arranged to guide the wort entering the container so that it flows in a circumferential direction along said inner surface portions, is comprised in said whirlpool arrangement. Additionally or alternatively, a portion of said container or said inner surface portions of said container that is arranged to guide the wort exiting the container is comprised in said whirlpool arrangement.

It should be understood that when stating that said whirlpool arrangement is configured to separate solids from the wort, it at least provides a condition for enabling separation of the solids from the wort. That is, the whirlpool arrangement is configured to create a whirl of said wort.

The cooling arrangement being arranged in said container between said inner surface portions and said outer surface portions allows for cooling of the wort without having the cooling arrangement disturb the whirlpool created inside said container. Thus, a stable whirlpool may be achieved that allows the wort to be cooled as the wort contacts the inner surface portions of the container. In other words, this allows solids to be separated from the wort while simultaneously cooling the wort. Moreover, by having the cooling arrangement arranged in said container between said inner surface portions and said outer surface portions, instead of e.g. inside said interior container space, cleaning of the inside of the container is facilitated. Another advantage of having said cooling arrangement arranged in said container between said inner surface portions and said outer surface portions, compared to e.g. outside of the container, is that the cooling effect of the inner surface portions of the container is improved, as the outer surface portions may act as an insulating layer. Moreover, by having a cooling arrangement in a tank which also provides a condition for the separation of solids from the wort, hops may be added to the wort in the tank in such a way that the bitterness extracted from the hops are held at a minimum (owing to the cooling arrangement cooling the wort inside the tank), while still enabling separation of the hops (owing to the whirlpool arrangement). Furthermore, by having a cooling arrangement arranged between said inner wall outside and said outer wall inside of the tank, and thereby cooling the wort inside the tank, any cooling device arranged subsequently in the brewing process may be dimensioned accordingly, e.g. be made smaller.

According to one example embodiment, said container comprises: an inner wall having an inner wall inside comprising said inner surface portions, and an inner wall outside facing away from said inner wall inside, an outer wall having an outer wall outside comprising said outer surface portions, and an outer wall inside facing away from said outer wall outside, and wherein said cooling arrangement is arranged between said inner wall outside and said outer wall inside in order to cool at least a portion of said inner wall.

Thus, the cooling effect of the inner surface portions of the container is improved, as the outer wall may act as an insulating layer. The inner wall is preferably made of a material with high heat conductive properties, e.g, metal. Thus, according to one embodiment, said inner wall is an inner sheet metal wall. By having an inner sheet metal wall, i.e. an inner wall made of sheet metal, heat transfer from the wort to the cooling arrangement is improved.

According to one example embodiment, the outer wall is preferably made of a material with low heat conductive properties. However, according to one embodiment, said outer wall is an outer sheet metal wall. Using a sheet metal for the outer wall may e.g. be beneficial for production reasons.

Said inner wall may be made from any material suitable for use in the food and beverage industry, for example stainless steel, aluminum, ceramic, or glass. Correspondingly, said outer wall may be made from any material suitable for use in the food and beverage industry, for example stainless steel, aluminum, ceramic, or glass. However, as the outer wall is not in contact with the wort, other materials than the previously mentioned may be used as well. According to one example embodiment, the outer wall is made of plastic or some other polymer-based material.

According to one example embodiment, the cooling arrangement is arranged to cool at least 25% of said inner wall, preferably at least 50%, and most preferably at least 75%.

According to one example embodiment, said cooling arrangement is attached to said inner wall outside of said inner wall. Hereby, said inner wall may be cooled by said cooling arrangement, thus allowing the wort in said container to be cooled.

According to one example embodiment, said container further comprises a thermal insulation layer. According to one example embodiment, said thermal insulation layer is at least partly, such as e.g mainly, arranged in said container between said cooling arrangement and said outer surface portions. For example, the thermal insulation layer may be attached to said outer wall inside of said outer wall. Thus, cooling efficiency is increased as the cooling arrangement is not heated by an atmosphere surrounding said tank.

According to one example embodiment, said container inlet is arranged to transport the wort into said interior container space by guiding at least a portion of the wort towards said inner wall inside of said inner wall.

Hereby, the wort is guided towards the inner wall inside which is cooled by said cooling arrangement Moreover, by guiding at least a portion of the wort towards said inner wall inside, the flow of wort inside the interior container space, the creation of the whirl is facilitated as the wort is forced to flow along the inner wall inside along the inner surface portions. Guiding the wort in a direction that intersects the inner wall inside furthermore causes the wort to flow turbulently in a proximity to a surface of said inner wall inside, thus increasing cooling efficiency.

According to one example embodiment, said whirlpool arrangement is a whirlpooling container inlet. Said whirlpooling container inlet may be arranged as and have the advantages of the aforementioned container inlet. According to one example embodiment, said whirlpooling container inlet is arranged to transport the wart into said interior container space by guiding at least a portion of the wort towards the inner surface portions, or towards the inner wall inside of said inner wall Moreover, the whirlpooling container inlet may comprise a plurality of inlet nozzles, each inlet nozzle being arranged as and have the advantages of the aforementioned container inlet. According to one example embodiment, said whirlpooling container inlet is arranged to transport the wort into said interior container space by guiding at least a portion of the wort in a direction that is substantially tangential to a portion of the inner surface portion or the inner wall inside of said inner wall. Thus, when the wort is fed into the container through the whirlpooling container inlet, the wort begins to whirl, or rotate, inside the container by, guided by the inner walls of said container.

According to one example embodiment said cooling arrangement comprises a cooling pipe.

Hereby, a cooling fluid may be led through the cooling pipe. According to one example embodiment said cooling pipe comprises a cooling pipe inlet for receiving a cooling liquid such as e.g. water. Thus, a cheap and accessible cooling liquid can be used. Furthermore, as water is typically non-toxic, a leakage of the water into the interior container space is less devastating as when using another cooling liquid, such as e.g. a toxic cooling liquid.

Hereby, the cooling pipe may receive the cooling liquid, such as e.g. water, and transport the cooling liquid inside said cooling pipe into said container. Thus, the cooling pipe may receive heat from inside of said interior container space, i.e. heat originating from the wort, and thereby cool said wort inside said tank.

According to one example embodiment, heat from the wort is transported to the inner wall inside of said inner wall, through said inner wall, to the inner wall outside and further to the cooling arrangement (e.g. the cooling pipe).

It should be understood that the cooling pipe typically comprises a cooling pipe inside and a cooling pipe jacket, and that the cooling pipe is arranged to transport heat from said cooling pipe jacket into said cooling pipe inside, through which a cooling liquid is arranged to flow.

According to one example embodiment, said cooling pipe inlet is arranged outside of said interior container space, such as e.g. outside of said outer surface portions of said container, or alternatively in said outer surface portions of said container. Hereby, the cooling pipe inlet is accessible from an outside of the tank and can easy be plugged into a cooling liquid source, such as e.g. a tap water connection line.

According to one alternative example embodiment, said cooling pipe inlet is arranged in said outer wall.

According to one example embodiment, the container comprises an intermediate space between said inner wall and said outer wall, that is an intermediate space between said inner wall outside and said outer wall inside. Hereby, the cooling arrangement, such as e.g. the cooling pipe, may be arranged in this intermediate space. For example, the cooling pipe may extend from an outside of the container, through said outer surface portions of the container and into said intermediate space. According to one example embodiment, the cooling pipe inlet is arranged inside this intermediate space. The cooling liquid may be transferred from e.g, an external cooling liquid source to said cooling pipe via said cooling pipe inlet by means of e.g. a coupling. The coupling may be positioned inside said intermediate space. According to one alternative example embodiment the coupling is positioned outside of said intermediate space, such as e.g. in said outer wall, or even outside of said outer wall.

According to one example embodiment, the before mentioned thermal insulation layer is arranged in said intermediate space. According to one example embodiment, the container is an insulated container. Thus, according to such example the container comprises an insulated layer, e.g. arranged between the inner surface portions and the outer surface portions of said container. Such an insulation layer may be arranged between said cooling arrangement and said outer surface portions of said container. Thus, the cooling efficiency is increased, as the cooling arrangement is insulated from the surrounding atmosphere.

According to one example embodiment, the cooling pipe is connected to said inner wall in order to cool at least a portion of said inner surface portions.

According to one example embodiment, the cooling arrangement is a tubular heat exchanger. A tubular heat exchanger is to be understood as being a heat exchanger comprising at least one tube for transporting the cooling liquid. According to one alternative embodiment, said cooling arrangement comprises an outer container or cooling mantle for holding, and transporting the cooling medium, in which outer container or cooling mantle the tank holding the wort that is to be cooled is located. In other words, the tank that is to be cooled is substantially submerged in or surrounded by the outer container or cooling mantle comprising the cooling medium, Thus, a cooling medium may flow freely between a cooling medium inlet and a cooling medium outlet, in a space (i.e. inside the outer container or cooling mantle) that is adjacent to said inner wall. Thus, a simple yet efficient cooling means is achieved, Any benefits or alternative embodiments regarding the cooling pipes are applicable to the cooling mantle heat exchanger as well, mutatis mutandis.

According to one example embodiment, said cooling pipe is arranged helically inside said container.

Hereby, heat from the wort may effectively be taken up by the cooling arrangement.

According to one example embodiment, the cooling pipe is configured so that the cooling liquid flows through said cooing pipe in a counterflow or a countercurrent relative the direction in which the whirlpool arrangement is configured to rotate the wort in, That is, the cooling pipe is arranged so that the cooling liquid is pumped therethrough in a rotational direction that is opposite the direction that the whirlpool arrangement is configured to cause the wort to rotate in. For example, if the whirlpool arrangement is configured to cause the wort to rotate in a counter clockwise direction, then the cooling arrangement may be arranged to transport the cooling liquid through the cooling pipe in a clockwise direction. Having a counterflowing cooling arrangement increases the efficiency of the cooling arrangement, as compared to a cocurrent flow, Thus, the amount of bitter taste that is released from the hops may be reduced.

According to one example embodiment, the cooling liquid may flow through said helical cooling pipe in a rotational direction that is opposite the direction that said whirlpool arrangement causes the wort to rotate in, and/or through said helical cooling pipe in an axial direction from a height at which the container outlet is arranged towards a height at which the container inlet is arranged. In other words, the flow of cooling liquid may be spiraling upwards through said helical cooling pipe. The relative direction upwards is to be understood in reference to the gravitational direction. Thus, the cooling liquid is counterflowing with respect the rotational whirl of the wort, and/or directed upwards, i.e, in a direction from said container outlet to said container inlet. This increases the cooling efficiency of the cooling arrangement.

According to one example embodiment, the cooling pipe is configured so that the cooling liquid flows through said cooing pipe in a cocurrent relative the direction in which the whirlpool arrangement is configured to rotate the wort in. That is, the cooling pipe is arranged so that the cooling liquid is pumped therethrough in a rotational direction that is the same as the direction that the whirlpool arrangement is configured to cause the wort to rotate in.

According to one example embodiment, the cooling liquid may flow through said helical cooling pipe in a rotational direction that is the same as the direction that said whirlpool arrangement causes the wort to rotate in, and/or through said helical cooling pipe in an axial direction from a height at which the container inlet is arranged towards a height at which the container outlet is arranged. In other words, the flow of cooling liquid may be spiraling downwards through said helical cooling pipe. Thus, the cooling liquid is cocurrent with respect the rotational whirl of the wort, and/or directed downwards, i.e. in a direction from said container inlet to said container outlet.

According to one example embodiment, said cooling arrangement is configured to lower the temperature of the wort to be between 50° C. and 80° C. That is, to lower the temperature of the wort inside the interior container space to be between 50° C. and 80° C.

According to one example embodiment, the cooling arrangement is configured to lower the temperature of the wort from a starting temperature that is more than 90° C., to a final temperature that is between 50° C. and 80° C. The final temperature is to be understood as being the temperature of the wort as it exits the container through a container outlet. The starting temperature is to be understood as being the temperature of the wort as is first comes into contact with a portion of the inner surface portions that have been cooled by the cooling arrangement,

By cooling the wort to a temperature that is between 50° C. and 80° C., the amount of bitterness extracted from the hops is decreased while allowing other taste substances to be extracted therefrom, Thus, by cooling the wort, for example at the same time as it is caused to whirl by said whirlpool arrangement, it is possible to get more aroma from the hops while avoiding extracting too much bitterness therefrom. Thus, it is e.g. possible to add more hops without the beer becoming too bitter.

According to one example embodiment, said cooling arrangement is configured to lower the temperature of the wort to be between 60° C. and 80° C., such as e.g. to be between 65° C. and 75° C.

According to one example embodiment, said container comprises a secondary container outlet fluidly connected to said interior container space, said secondary container outlet being arranged vertically lower compared to said container outlet. Hereby, the residual wort comprising a high amount of solids which is left in the container as the main wort has been discharged from the tank, can be discharged in a convenient way through said secondary container outlet,

According to one example embodiment, said tank is a whirlpool tank.

According to one example embodiment, said tank is a combined boiling kettle and whirlpool tank. In such embodiments, the tank further comprises a heating arrangement configured to heat the wort and being arranged in said container between said inner surface portions and said outer surface portions. The heating arrangement may e.g. be a heating coil. According to one example embodiment, the heating arrangement is arranged vertically below said cooling arrangement. According to one example embodiment, the heating arrangement is located in a bottom portion of the tank. Preferably, the heating arrangement in such a combined boiling kettle and whirlpool tank is arranged in close proximity to the bottom of the tank, such as e.g. in an end portion of the tank extending up to 30%, or 50%, of the tank as measured in the vertical direction from the bottom of the tank. The cooling arrangement in such a combined boiling kettle and whirlpool tank is arranged over the majority of the side wall of the tank, such as e.g. extending up to 90%, or 75%, of the tank as measured in the vertical direction from the bottom of the tank.

According to one example embodiment, said heating arrangement and said cooling arrangement are separated by an insulating layer.

According to a second aspect of the present invention a method for reducing the temperature of a wort inside a tank while separating solids therefrom is provided, said method comprising the steps of:

feeding the tank with a wort;

causing said wort to whirl;

cooling said wort with a cooling arrangement arranged inside of said tank.

The method according to the second aspect of the present invention may be used with a tank according to the different embodiments of the first aspect of the present invention. The advantages described above for any of these features are also valid for the second aspect of the present invention. Moreover, any embodiments mentioned in relation to the first aspect of the invention is applicable to the second aspect of the invention as well.

In one exemplary embodiment, the wort is fed into said tank for 10-40 minutes. Before feeding the wort to the tank, the tank may be substantially empty. After the wort has been fed into the tank, the tank may be substantially full, or have a relatively small empty headspace over the surface of the wort. In one exemplary embodiment, the step of cooling said wort with a cooling arrangement is carried out at least partly simultaneously with said step of feeding the tank with the wort.

According to one exemplary embodiment of the second aspect of the present invention, hops are added to the wort simultaneously as the wort is being fed into the tank. This prevents the hops from potentially disrupting any whirl created inside the wort.

According to one exemplary embodiment, the method comprises the step of causing the wort to whirl inside the tank. For example, and according to one exemplary embodiment of the second aspect of the present invention, the wort is caused to whirl by being fed into the tank in a direction that is substantially tangential to a curvature of the tank.

According to one exemplary embodiment of the second aspect of the present invention, said wort is caused to stop whirling. For example, the wort may be caused to stop whirling by waiting for the whirl to slow down on its own. As the whirl slows down and stops, solids held suspended in the wort migrate towards a bottom center of the whirl, so that a small pile of solids is formed there. The step of causing said whirl to stop may take e.g. 10-30 minutes.

According to one exemplary embodiment of the second aspect of the present invention, at least a portion of said wort is drained from said tank. The wort drained from the tank may e.g. be discharged from a container outlet, and be further transported to subsequent steps of the brewing process, such as e.g. further cooling and fermentation. According to one exemplary embodiment of the second aspect of the present invention, at least a portion of said wort is drained from said tank after the wort has stopped whirling.

According to one exemplary embodiment of the second aspect of the present invention, the wort is boiled, or caused to boil, after being fed into the tank. This is beneficial as it allows for the use of a combined boiling kettle and whirlpool tank.

According to one exemplary embodiment of the second aspect of the present invention, the solids, or residual wort comprising the solids, are removed from said tank.

Described differently, and according to one example embodiment, said tank is configured to work in a multistep manner. That is, in a first step, the wort is fed to the tank (which could be described as feeding a batch of wort to the tank) in the previously described manner causing a whirl of wort, or whirlpool, to be created, The solids that are to be separated from the wort are thus caused to move towards a centre of the interior container space by the whirl, or whirlpool, In a second step, the feeding of the wort to the tank is stopped, and the solids in the wort are allowed to settle in a cone-shaped pile on the bottom of the container. In a third step, the wort is removed, or discharged, from the container via said container outlet. In a fourth step, the solids, and any residual wort comprising a high amount of solids, are removed from the container via said container outlet, or secondary container outlet.

For example, according to one embodiment of the second aspect of the present invention, said method further comprises the steps of: providing a tank comprising a container having inner surface portions defining an interior container space, and outer surface portions facing away from said interior container space, a container inlet for transporting the wort into said interior container space, and a cooling arrangement arranged in said container,

wherein the step of cooling said wort with a cooling arrangement comprises cooling at least a portion of said inner surface portions in order to cool the wort in said interior container space.

According to one example embodiment of the second aspect of the present invention, said cooling arrangement is arranged between said inner surface portions and said outer surface portions of said container.

According to one example embodiment of the second aspect of the present invention, the step of cooling said wort with a cooling arrangement comprises lowering the temperature of the wort to between 50° C. and 80° C.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional objects, features and advantages of the present invention, will be better understood through the following illustrative and non-limiting detailed description of exemplary embodiments of the present invention, with reference to the appended drawing, wherein:

FIG. 1 is a perspective view of a tank according to one exemplary embodiment of the first aspect of present invention,

FIGS. 2a-2d illustrate how the separation of solids from the wort can be carried out in four subsequent steps, and

FIG. 3 is a schematic view of a tank according to one exemplary embodiment of the first aspect of the invention.

### DETAILED DESCRIPTION OF THE DRAWINGS

In the present detailed description, embodiments of a tank according to the present invention are mainly discussed with reference to drawings showing a tank with components and portions being relevant in relation to various embodiments of the invention. It should be noted that this by no means limits the scope of the invention, which is also applicable in other circumstances for instance with other types or variants of tanks than the embodiments shown in the appended drawings. For example, the invention may be used with boilers, whirlpool tanks or other tanks used in the process of brewing beer. Further, that specific features are mentioned in connection to an embodiment of the invention does not mean that those components cannot be used to an advantage together with other embodiments of the invention.

The invention will now by way of example be described in more detail by means of embodiments and with reference to the accompanying drawings.

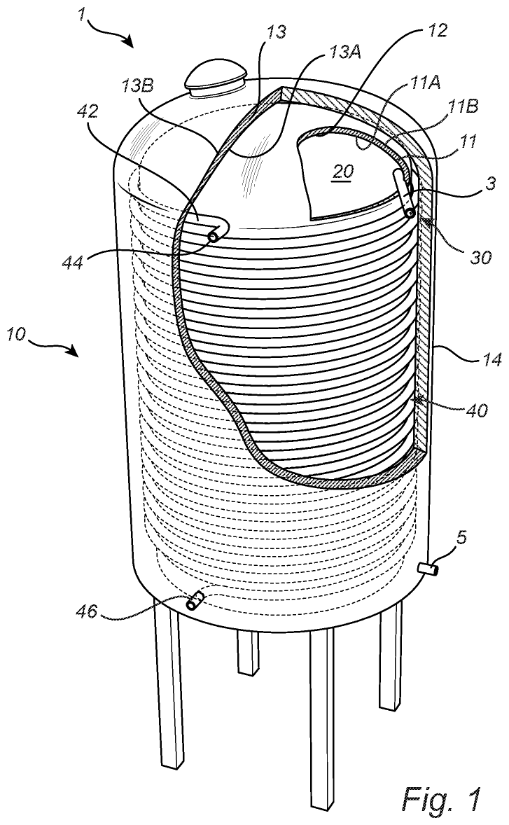

FIG. 1 is a perspective view of a tank 1 according to one exemplary embodiment of the first aspect of present invention. The tank 1 of FIG. 1 is a whirlpool tank 1, i.e. with the main purpose of separating solids from the wort. However, as described previously, the tank 1 may be part of a combined boiler kettle and whirlpool tank.

The tank 1 comprises a container 10 having inner surface portions 12 defining an interior container space 20, and outer surface portions 14 facing away from the interior container space 20. In the container 10 of FIG. 1, the inner surface portions 12 is comprised in an inner wall 11 having an inner wall inside 11A comprising the inner surface portions 12. The inner wall 11 further comprises an inner wall outside 11B facing away from the inner wall inside 11A. Correspondingly, the container 10 comprises an outer wall 13 having an outer wall outside 13B comprising the outer surface portions 14, and an outer wall inside 13A facing away from the outer wall outside 13B.

The tank 1 further comprises a whirlpool arrangement 30 configured to create a whirl of said wort in order to separate solids from the wort, and comprises a cooling arrangement 40 configured to cool at least a portion of the interior container space 20 for cooling the wort. As seen in FIG. 1 the cooling arrangement 40 is arranged in the container 10 between the inner surface portions 12 and the outer surface portions 14. More specifically, the cooling arrangement 40 is arranged between the inner wall outside 11B and the outer wall inside 13A in order to cool at least a portion of the inner wall 11. As also shown in FIG. 1, parts of the outer wall 13 are cut away for showing internal parts, such as the cooling arrangement 40, of the container 10.

The cooling arrangement 40 in FIG. 1 comprises a cooling pipe 42 which is arranged helically inside the container, extending along at least a portion of the height of the container. The cooling pipe 42 has a cooling pipe inlet 44 and a cooling pipe outlet 46, both arranged outside of the outer surface portions 14 of the outer wall 13, in connection to the outer wall 13. It should be understood that the cooling arrangement 40, such as the cooling pipe 42, is sized and dimensioned to lower the temperature of the wort to be between 50° C. and 80° C. For example, the flow of cooling liquid, such as e.g. water, may be in the range of 0.01 m³/min to 2 m³/min and hold a temperature at the cooling pipe inlet 44 of about 5-10° C. However, as understood by those skilled in the art, the flow and temperature of the cooling liquid is adapted to correspond to target temperature reduction of the wort, by also including parameters such as e.g. the size of the tank 1, the design of the cooling arrangement 40 (e.g. the inner diameter, the thickness of the walls, and the material of the cooling pipe 42, as well as the rotational velocity of the whirl in the tank 1 and the fill rate of the wort into the tank 1) and the amount of wort inside the interior container space 20 as well as the initial temperature of the wort fed to the tank 1. The flow of cooling liquid may be above or below than the abovementioned range, depending on the requirements of the application.

The tank 1 in FIG. 1 further comprises a container inlet 3 for transporting the wort into the interior container space 20, and a container outlet 5 for transporting the wort out of the interior container space 20. As seen in FIG. 1, the container outlet 5 is located lower than the container inlet 3 (the relative direction lower is to be interpreted in a vertical direction along the gravitational direction).

The tank 1 is arranged so that wort may be extracted through said container outlet 5, the extracted wort containing less solids than the wort that is fed into the container inlet 3 of said tank 1. The solids that are to be separated from the wort are caused to move towards a centre of the interior container space 20 by the whirlpool that is created in said interior container space 20, after which they settle in a cone-shaped pile on the bottom of the container 1, removing the wort from the interior container space 20 by means of a container outlet 5 that is located near a peripheral portion of the lower portion or bottom of the container 1 is beneficial.

It should be understood that the whirlpool arrangement 30 may comprise parts and portions of the tank 1 for enabling a whirl of the wort to be created inside the interior container space 20. Thus, for example as shown in FIG. 1, the container inlet 3 is at least partly tangentially arranged such that at least a portion of the wort is guided/injected towards the inner surface portions 12 or the inner wall inside 11A of the inner wall 11, Moreover, the inner wall, and thus inner wall inside 11A and the inner surface portions 12, are curved for allowing the feed of wort to be rotationally transported inside the container 10. In other words, the whirlpool arrangement 30 is to be understood as being an arrangement configured to cause a whirlpool of the wort.

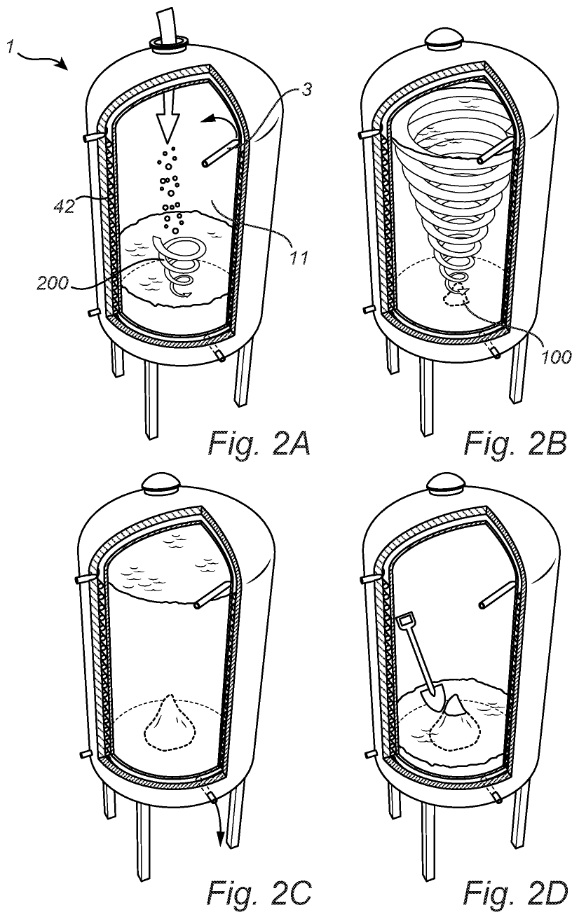

FIGS. 2a-d show the method of separating solids from a wort in four steps, by using the tank 1 of FIG. 1. First, FIG. 2a shows the wort being added to the tank 1 through the container inlet 3. As the wort enters the tank 1, a whirl 200 is created due to the wort being discharged from the container inlet 3 in a direction that is tangential to the curvature of the inner wall 11 of the tank 1 such that the wort hits the inner wall 11 and begins to rotate inside the tank 1. Simultaneously as the wort is being added to the tank 1, hops may be added in order to alter the flavor of the beer that is to be created. A cooling medium is pumped through the cooling pipe 42 that is arranged around the tank 1, thus lowering the temperature of the wort as soon as it enters the tank 1.

FIG. 2b shows the tank 1 after it has been filled with wort. The wort whirls inside the tank 1 due to the arrangement of the container inlet 3 and the curvature of the inner wall 11 of the tank 1. As the whirl 200 is created in the wort, any solids suspended therein are forced towards the centre of the whirl 200 by fluid pressure from the portion of the wort that flows in the outer or peripheral portion of the whirl 200. Thus, when the wort whirls, any solids suspended therein are slowly deposited in a pile located at the central bottom portion of the tank 1. The cooling pipe 42 continues to cool the wort as the whirl 200 slows down to a stop.

FIG. 2c shows the tank 1 after the wort has slowed down to a halt and the solids previously suspended therein have been deposited in a pile 100 at the bottom of the tank 1. The wort is then discharged from the tank 1 through the container outlet 5. The wort that is discharged therethrough contains less solids than the wort that entered the tank 1 thorough the container inlet 3 in the first step.

FIG. 2d shows the tank 1 after most of the wort has been discharged. A pile 100 of solids remains, together with some of the wort. The solids are then removed from the tank, e.g. manually or through a drainage outlet (not shown). After the solids and the last of the wort has been removed, the tank 1 is cleaned and the process may be repeated with another batch of wort and hops.

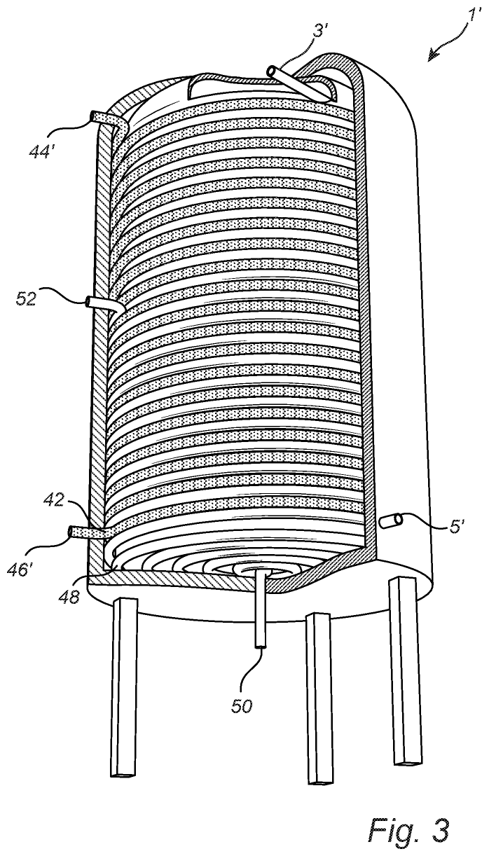

FIG. 3 is a schematic view showing a combined boiling kettle and whirlpool tank 1′ according to one exemplary embodiment of the first aspect of the invention. The combined boiling kettle and whirlpool tank 1′ comprises a container inlet 3′ and a container outlet 5′. The tank 1′ further comprises a cooling pipe 42′ having a cooling pipe inlet 44′ and a cooling pipe outlet 46′, and a heating pipe 48 having a heating pipe inlet 50 and a heating pipe outlet 52. The tank 1′ may be provided with a whirlpool arrangement like the tank 1 in FIGS. 1-2, or it may be provided with a rotating paddle, ladle or arm (not shown) arranged to cause the wort to rotate. The tank 1′ may be used for first boiling the wort using the heating pipe 48, after which the wort is caused to whirl while simultaneously being cooled by the cooling pipe 42′. The heating pipe 48 extends over approximately the lower half of the side wall of the tank 1′. The heating pipe 48 extends so that it covers a bottom portion of the tank 1′. The cooling pipe 42′ extends over approximately the entire side of the tank 1′. This allows a wort to be fed into the tank 1′ while simultaneously using the heating pipe 48 for bringing the wort to a boil. After the wort has been caused to boil, the heating pipe 48 ceases to heat the wort and the cooling pipe 42′ causes the wort to cool down. While cooling the wort, it is also brought to a whirl by the whirlpool arrangement.

Generally, all terms used in the claims are to be interpreted according to their ordinary meaning in the technical field, unless explicitly defined otherwise herein. All references to “a/an/the [element, device, component, means, step, etc.]” are to be interpreted openly as referring to at least one instance of said element, device, component, means, step, etc., unless explicitly stated otherwise. Furthermore, any reference signs in the claims should not be construed as limiting the scope.

1. A tank for separating solids from a wort, said tank comprising:
a container having inner surface portions defining an interior container space, and outer surface portions facing away from said interior container space;
a whirlpool arrangement configured create a whirl of said wort;
wherein said tank further comprises a cooling arrangement configured to cool at least a portion of said interior container space for cooling the wort, and
wherein said cooling arrangement is arranged in said container between said inner surface portions and said outer surface portions.

2. The tank according to claim 1, wherein said container comprises:
an inner wall having an inner wall inside comprising said inner surface portions, and an inner wall outside facing away from said inner wall inside,
an outer wall having an outer wall outside comprising said outer surface portions, and an outer wall inside facing away from said outer wall outside, and wherein
said cooling arrangement is arranged between said inner wall outside and said outer wall inside in order to cool at least a portion of said inner wall.

3. The tank according to claim 2, further comprising a container inlet arranged to transport the wort into said interior container space by guiding at least a portion of the wort towards said inner wall inside of said inner wall.

4. The tank according to claim 1, wherein said cooling arrangement comprises a cooling pipe.

5. The tank according to claim 4, wherein said cooling pipe is arranged helically inside said container.

6. The tank according to claim 1, wherein said cooling arrangement is configured to lower the temperature of the wort to be between 50° C. and 80° C.

7. A method for reducing the temperature of a wort inside a tank while separating solids therefrom, said method comprising the steps of:
feeding the tank with a wort;
causing said wort to whirl;
cooling said wort with a cooling arrangement arranged inside of said tank.

8. The method according to claim 7, further comprising the steps of:
providing a tank comprising a container having inner surface portions defining an interior container space, and outer surface portions facing away from said interior container space, a container inlet for transporting the wort into said interior container space, and a cooling arrangement arranged in said container,
wherein the step of cooling said wort with a cooling arrangement comprises cooling at least a portion of said inner surface portions in order to cool the wort in said interior container space.

9. The method according to claim 7, wherein said cooling arrangement is arranged between said inner surface portions and said outer surface portions of said container.

10. The method according to claim 7, wherein the step of cooling said wort with a cooling arrangement comprises lowering the temperature of the wort to between 50° C. and 80° C.
